(19) United States
(12) Patent Application Publication
(10) Pub. No.: US 2013/0344345 A1
(43) Pub. Date: Dec. 26, 2013

(54) BIAXIALLY ORIENTED BIO-BASED POLYESTER WINDOW FILMS AND LAMINATES

(71) Applicant: TORAY PLASTICS (AMERICA), INC., (US)

(72) Inventors: Stefanos L. SAKELLARIDES, East Greenwich, RI (US); Keunsuk P. CHANG, North Kingstown, RI (US); Milan William Moscaritolo, Westerly, RI (US)

(73) Assignee: TORAY PLASTICS (AMERICA), INC., N. Kingstown, RI (US)

(21) Appl. No.: 13/874,141

(22) Filed: Apr. 30, 2013

Related U.S. Application Data
(63) Continuation-in-part of application No. 13/179,007, filed on Jul. 8, 2011.

(51) Int. Cl. C08G 63/16; C08K 5/3475; C08K 5/3492; C08K 5/357

(52) U.S. Cl. CPC C08G 63/16; C08K 5/357; C08K 5/3475; C08K 5/3492
USPC 428/458; 528/308.1; 524/605; 524/87; 524/91; 524/100; 428/480

(57) ABSTRACT

A bio-based polyester window film optionally including a a UV light absorbing layer including a bio-based polyester and a UV light absorber. The bio-based polyester window film has a radiocarbon content of at least 19 pMC. The film exhibits excellent clarity and light stability, substantially equivalent to petroleum-based counterparts, while being derived wholly or partly from non-petroleum sources.

### CROSS-REFERENCE TO RELATED APPLICATION

This application is a continuation-in-part of U.S. application Ser. No. 13/179,007, filed Jul. 8, 2011, the contents of which are incorporated herein by reference in their entirety.

### FIELD OF INVENTION

This invention relates to biaxially oriented window films comprising a bio-based polyester, such as polyethylene terephthalate (abbreviated as “PET”), which is derived from non-petroleum-sourced monomers. This invention also relates to multi-layer biaxially oriented polyester films and laminates for window films, which are made from at least one bio-based polyester building block, such as bio-based ethylene glycol or bio-based terephthalic acid.

### BACKGROUND OF THE INVENTION

Biaxially oriented polyester films are used for packaging, industrial, electronic, decorative, architectural, and label applications and often perform multiple functions.

For example, biaxially oriented PET films and laminations are popular, high performing, and cost-effective flexible substrates for a variety of snack food packaging applications. Such packaging films must perform in a lamination to provide printability, transparent or matte appearance, or slip properties; they sometimes must provide a surface suitable for receiving organic or inorganic coatings for gas and moisture barrier properties; they sometimes must provide a heat sealable layer for bag forming and sealing, or a layer that is suitable for receiving an adhesive either by coating or laminating.

In recent years, interest in “green” packaging has been developing strongly. Packaging materials based on biologically derived polymers are increasing due to concerns with non-renewable resources, raw materials, and greenhouse gas generation. Bio-based polymers are believed—once fully scaled-up—to reduce reliance on petroleum, reduced production of greenhouse gases, and are derived from renewable or sustainable sources such as plants. Bio-based polymer such as polylactic acid (PLA)—which is currently derived from corn starch—is one of the more popular and commercially available materials that can be used for packaging film applications.

For such a bio-based polymer to be fit-for-use for many snack food packaging applications, it is desirable that the bio-based polymer film match as many of the attributes possible that—for example—multi-layer biaxially-oriented PET is well-known for, such as thermal and dimensional stability, heat sealability, printability, controlled coefficient of friction (COF), metalizability, gas transmission barrier, etc. In particular, for high barrier packaging, metalized bio-based oriented films should demonstrate good oxygen and moisture barrier properties. For example, in the case of a metalized oriented PLA, good oxygen barrier property is generally easily achieved due to the polar nature of PLA, which provides good hydrogen-bonding of the polymer molecules. However, this polar nature tends to be detrimental for achieving high moisture barrier. Without being bound by any theory, the thought is that water molecules—being polar themselves—may more easily migrate through a polar polymer film than a non-polar polymer film. In addition, it is possible that the PLA substrate can absorb moisture and swell, thus changing the physical and dimensional properties of the PLA substrate. In particular, such swelling—especially at the interface between the vapor-deposited metal in a metalized PLA film and the adjacent PLA substrate surface—can cause morphological and dimensional changes in which the relatively inflexible inorganic metal layer can not conform to. This can then result in cracking of the metal layer and attendant loss of gas barrier properties. BOPET films, however, exhibit excellent oxygen gas barrier properties and reasonably good moisture barrier properties due to its high T_{g}, crystallinity, and aromatic structure. BOPET is less subject to swelling and dimensional changes due to moisture, although it does share some of the sensitivity to moisture that BOPLA does due to its polar nature.

There are other issues inherent with bio-polymers such as PLA used in flexible packaging applications. BOPLA typically has lower thermal resistance and higher heat shrinkage than BOPET which can be a problem in downstream processes seen in converting such as drying temperatures after printing or coating, extrusion lamination, and metalizing. In fact, the high thermal resistance and dimensional stability of BOPET films is what make them useful and attractive in many applications. In addition, from an end-user stand-point, the high stiffness of BOPLA packaging can make it prone to dead-fold issues whereby the package can be easily creased, causing a shelf-worn appearance; and furthermore, the BOPLA package can be much noisier than a BOPET package which can be a complaint from the consumer.

However, if BOPET packaging can be made from bio-based sources instead of petroleum sources, this would solve the converting, end-user, and consumer concerns that BOPLA packaging entails, while reducing reliance on petroleum, reducing overall potential carbon footprint, and being produced from a sustainable resource (plants). The only drawback would be that unlike BOPLA or some other bio-polymers, BOPET would not be compostable or degradable without modifying additives. However, without being bound by any theory, a bio-based/sourced BOPET could be a way to sequester carbon dioxide from the atmosphere as the source plant material could take in CO₂ from the atmosphere which is then converted to polyesters such as polyethylene terephthalate and then converted to polyester packaging which does not degrade and return CO₂ to the atmosphere.

Coca-Cola Company's US patent application publication 20090246430A1 states that “It is known in the art that carbon-14 (C-14), which has a half life of about 5,700 years, is found in bio-based materials but not in fossil fuels. Thus, “bio-based materials” refer to organic materials in which the carbon comes from non-fossil biological sources. Examples of bio-based materials include, but are not limited to, sugars, starches, corns, natural fibers, sugarcanes, beets, citrus fruits, woody plants, cellulosics, lignocelluosics, hemicelluloses, potatoes, plant oils, other polysaccharides such as pectin, chitin, levan, and pullulan, and a combination thereof . . . . As explained previously, the detection of C-14 is indicative of a bio-based material. C-14 levels can be determined by measuring its decay process (disintegrations per minute per gram carbon or dpm/gC) through liquid scintillation counting. In one embodiment of the present invention, the bio-based PET polymer comprises at least about 0.1 dpm/gC (disintegrations per minute per gram carbon) of C-14.” This is a useful definition of bio-based materials to distinguish them from their traditional petroleum-based counterparts. This reference teaches the use of bio-based ethylene glycols and terephthalic acids to form a bio-based polyethylene terephthalate resin useful for beverage bottles.

US patent application publication 20100028512A1 describes a method to produce bio-based polyester terephthalate (PET) resin which may then be used to make articles, containers, or packaging for food and beverage products. The application also discloses the use of bio-based polyethylene to produce closures, caps, or lids for bio-based PET containers as well as the use of bio-based polyethylene labels via film extrusion for said containers. However, there is no contemplation of producing bio-based polyethylene terephthalate films for packaging applications.

### SUMMARY OF THE INVENTION

Methods for producing useful window films and laminations using bio-based polyethylene terephthalate homopolymers and copolymers are described. Such bio-based polyester articles will contain a certain amount of ¹⁴C-isotope, a quantity that is thus distinguishable from petroleum-based polyesters. These bio-based polyesters are made from, in turn, bio-based monomers, which are derived from plant-based intermediates such as alcohols and sugars.

The above issues of making high gas and moisture barrier metalized BOPET films and laminations from at least partially bio-based polyethylene terephthalate homopolymers and copolymers are addressed. The inventors have found solutions whereby the use of such materials in window films can maintain current levels of quality, processability, and capital assets while reducing net carbon dioxide emissions.

Biaxially oriented PET films and laminations are popular, high-performing, and cost-effective substrates for applications providing solar protection, such as window films. Such window films must often have very low haze in order to satisfy end-user applications. At the same time, they require ease in handling and processing and scratch resistance. This dual requirement may be accomplished, for example, by incorporating particles, offering anti-block, slip, and anti-scratch characteristics but having a size below or within the range of visible light wavelength so as to prevent significant light diffraction that would result in haze. A very tangible benefit is the significant reduction of high angle sun haze, a factor in many solar applications.

Window films may be dyed or metalized (to an optical density that still leaves the film transparent to visible light) or have ceramic coated applied to convert incoming solar radiation to infrared radiation, which is then rejected back through the glass to the exterior.

The adhesive system used in window films rejects UV Radiation up to 380 nm. As UV is one of the main sources of fading, it can prolong the life of fixtures and fittings. Specialty UV Window Films are available that offer increased protection to 400 nm, through incorporation of high-performance UV absorbers, which also increase the shelf life of the film itself.

It has been found that bio-based PET may be substituted for petroleum-derived PET in window film manufacturing without affecting the clarity and light stability. At the same time, the use of this bio-based PET enhances the environmental benefits provided by window films. In addition to reducing the energy required to cool or heat buildings window films made from bio-derived PET further reduces the carbon footprint associated with a building and thus makes the use of these films even more attractive to home and commercial real estate purchasers that prefer a more environment-friendly construction.

Bio-based polyethylene terephthalate or other polyesters differ from conventional petroleum-based polyesters in that ¹⁴C-isotope measurements show that the quantity of ¹⁴C in bio-sourced materials is significantly higher than in petroleum-based materials due to the continual uptake of this isotope by living plants and organisms. In petroleum-derived polyethylene terephthalate, however, ¹⁴C-isotope is essentially undetected using ASTM International standards (ASTM D6866). This is due to the half-life of ¹⁴C (about 5730±40 years) and the decay of this isotope over the hundreds of millions of years since the original organisms existed, took up said ¹⁴C, and turned into petroleum. Thus, bio-based or bio-sourced polyesters may be characterized by the amount of ¹⁴C they contain. The decay of ¹⁴C isotope is famously known for radiocarbon-dating of archeological, geological, and hydrogeological artifacts and samples and is based on its activity of about 14 disintegrations per minute (dpm) per gram carbon.

Embodiment of a a laminate film may include a first bio-based polyester resin-containing layer B, said bio-based polyester selected from the group of polyethylene terephthalate, polyethylene naphthalate, polybutylene terephthalate, polytrimethylene terephthalate, polyethylene terephthalate-co-isophthalate copolymer, polyethylene terephthalate-co-naphthalate copolymer, polycyclohexylene terephthalate, polyethylene-co-cyclohexylene terephthalate, etc. and other ethylene glycol or terephthalic acid-based polyester homopolymers and copolymers and blend combinations thereof. This first bio-based polyester resin-containing layer B could be considered a base or core layer.

One particular embodiment of such a film-forming polyester is polyethylene terephthalate (abbreviated as “PET”) homopolymer or copolymer with one or both of its major monomer building blocks, terephthalic acid or ethylene glycol, derived from biological sources. Such films exhibit excellent properties, including gas barrier properties particularly after metalizing, substantially equivalent to their petroleum-based counterparts, while being derived wholly or partly from non-petroleum sources.

The bio-based content of the polyester can be characterized using test procedure ASTM D6866 which measures the amount of ¹⁴C isotope (also known as “radiocarbon”) in said polyester and compares it to a modern reference standard. This ratio of measured ¹⁴C to the standard can be reported as “percent modern carbon” (pMC). Petroleum or fossil fuel-based polyester will have essentially 0% radiocarbon (0 pMC) whereas contemporary 100% bio-based or bio-mass polyester should have about or near 100% radiocarbon (105.3 pMC). It is preferable that the ratio of biomass-based polyester to petroleum-based polyester in layer B be at least 1 pMC, and more preferably at least about 19 pMC, and even more preferably, about 105.3 pMC.

In a further embodiment, the laminate could include a second polyester resin-containing layer A contiguously attached upon one side of the first bio-based polyester resin-containing layer B. This second polyester resin-containing layer A could be either a petroleum-based polyester or a bio-based polyester like the first layer B. Preferably, this second layer A is also a bio-based polyester resin-containing layer of at least 1.0 pMC, preferably at least about 19 pMC, at least about 21.5 pMC, at least or at least about 105.3 pMC. Furthermore, the laminate could further embody a third polyester resin-containing layer C contiguously attached on the side of the first bio-based polyester resin-containing core layer B, opposite the second polyester resin-containing A. Preferably, as with the second polyester layer A, the third polyester resin-containing layer C is also comprised of a bio-based polyester of at least 1.0 pMC, preferably at least about 19 pMC, and more preferably, about 105.3 pMC. Other embodiments could comprise or contemplate additional intermediate layers between the layers A and B and between the layers B and C. Such intermediate layers of the multi-layer structure may be symmetrically or asymmetrically disposed around the bio-based polyester core layer B. Preferably, such intermediate layers are also comprised of bio-based polyesters or bio-based polyolefins for the purpose of ensuring as high a content of bio-sourced sustainable materials in the overall multi-layer laminate film structure. Preferably, said intermediate layers should be at least 1.0 pMC, at least about 19 pMC, at least about 21.5 pMC, at least about or at least 105.3 pMC.

Preferably, the second bio-based polyester resin-containing layer A comprises a formulation suitable for receiving a metal layer via vapor deposition by processes well-known in the art, preferably comprising aluminum with a thickness of about 5-100 nm and optical density of about 1.5-5.0. Additionally, this layer can also be suitably formulated for receiving printing inks or coatings as desired. Layer A is a preferably bio-based polyester selected from the group, but not limited to, polyethyene terephthalate homopolymer, polyethyene terephthalate copolymers with isophthalic acid, naphthalate dicarboxylic acid, cycloehexane dimethanol (CHDM), diethylene glycol, butanediol, propanediol, adipic acid, sebacic acid, azelaic acid, hexylenediol, and/or blends thereof to achieve good metal adhesion or printing ink adhesion. The outer surface of layer A (the surface opposite the side in contiguous contact with layer B) may be discharge-treated by various means in the art (e.g. corona discharge treatment, flame treatment, controlled atmosphere corona treatment, atmospheric plasma treatment) so as to raise further the surface energy/wetting tension of the surface to make it more receptive for metal deposition or ink adherence. Other means of enhancing the suitability of the surface for the reception of metal deposition, inks, adhesives, etc., may be achieved by chemical treatments or coatings. In addition, an amount of antiblock may be incorporated into the bio-based polyester layer A comprising an antiblock component selected from the group comprising, but not limited to, amorphous silica, aluminosilicate, sodium calcium aluminum silicate, crosslinked silicone polymer, polymethylmethacrylate, and/or blends thereof.

Preferably, the third bio-based polyester resin-containing layer C comprises a heat-sealable amorphous polyester selected from the group comprising, but not limited to, polyethylene terephthalate copolymers with co-monomers such as isophthalic acid, cyclohexane dimethanol, and/or blends with polyethylene terephthalate homopolymers thereof. This preferably bio-based heat-sealable layer C also comprises an antiblock component selected from the group comprising of, but not limited to, amorphous silica, aluminosilicate, sodium calcium aluminum silicate, crosslinked silicone polymer, polymethylmethacrylate, and/or blends thereof.

Alternatively, the third bio-based polyester resin-containing layer C could also comprise a non-heat-sealable winding layer comprising a bio-based crystalline polyester and an inorganic antiblocking agent for controlling coefficient of friction (“COF”). This non-heat-sealable winding layer can comprise a crystalline polyester homopolymer with an antiblock component selected from the group comprising, but not limited to, amorphous silicas, aluminosilicates, sodium calcium aluminum silicate, a crosslinked silicone polymer, and polymethylmethacrylate. Preferably, the crystalline polyester homopolymer is made from bio-sourced polyester building blocks. In this embodiment, the winding layer may also be a discharge-treated or chemically-treated winding layer having a surface for lamination or coating with adhesives or inks.

Another embodiment is a method for flexible packaging comprising obtaining a laminate film comprising a bio-based polyester resin-containing layer and surrounding a product by the laminate film. Preferably, the product is a food product.

In yet another embodiment, this invention provides biaxially oriented bio-based polyester multi-layer films for flexible packaging purposes. Another embodiment provides a metalized biaxially oriented bio-based polyester multi-layer barrier films. An additional embodiment provides laminate structures of bio-based polyester layers and metalized layers for barrier applications in flexible packaging or in decorated balloons. An additional embodiment is monolayer biaxially oriented polyester films for use in thermal transfer ribbons. Another embodiment is monolayer or multilayer biaxially oriented polyester film optionally containing UV absorber additives for use in solar window film structures. Another embodiment would be white polyester film for use in outdoor applications such as advertising signs or photovoltaic back panels.

Embodiments of a bio-based polyester window film may include a bio-based polyester, wherein the bio-based polyester window film has a radiocarbon content of at least 19 pMC. The film may further include a UV light absorber and/or a Hindered Amine Light Stabilizer (HALS). The UV light absorber may include 2,2′-(1,4-phenylene)bis([3,1]benzoxazin-4-one), 2,2′-methylene bis[6-(2H-benzotriazol-2-yl)-4-1,1,3,3-tetramethylbutyl)phenol], 2-(4,6-diphenyl-1,3,5-triazin-2-yl)-5-hexyloxyphenol, or 2,4-bis-biphenyl-6-[2-hydroxy-4-(2-ethyl-hexyloxy)phenyl]-1,3,5-triazine. The UV light absorber may include a triazine.

In some embodiments, the film may have an average UV light transmission in the range of 300-400 nm of less than 18%, and may have an average UV light transmission in the range of 310-380 nm of less than 6%. The film may be biaxially oriented. The film may include crystalline polyethylene terephthalate. The bio-based polyester's bio-based renewable source may be derived from a plant sugar such as cane sugar, beet sugar, or corn sugar.

In some embodiments, an outermost surface of the film may be discharge-treated. A metal or metal oxide layer may be deposited on a surface of the film. The metal or metal oxide layer may be transparent. In some embodiments, the bio-based polyester window film may further include an adhesive layer. The adhesive layer may be formulated to reject UV radiation up to 380 nm.

Embodiments of a window structure may include a window and the bio-based polyester window film described herein.

Embodiments of a lamination may include a first biaxially oriented bio-based polyester film comprising at least 19 pMC, a second biaxially oriented bio-based polyester film comprising at least 19 pMC, and an adhesive layer between the first biaxially oriented bio-based polyester film and the second biaxially oriented bio-based polyester film.

The first or second bio-based biaxially oriented polyester film may include a UV light absorber. The first or second bio-based biaxially oriented polyester film may include a Hindered Amine Light Stabilizer (HALS). The UV light absorber may include 2,2′-(1,4-phenylene)bis([3,1]benzoxazin-4-one), 2,2′-methylene bis[6-(2H-benzotriazol-2-yl)-4-1,1,3,3-tetramethylbutyl)phenol], 2-(4,6-diphenyl-1,3,5-triazin-2-yl)-5-hexyloxyphenol, or 2,4-bis-biphenyl-6-[2-hydroxy-4-(2-ethyl-hexyloxy)phenyl]-1,3,5-triazine. The UV light absorber may include a triazine.

In some embodiments, the lamination may have an average UV light transmission in the range of 300-400 nm of less than 18%, and may have an average UV light transmission in the range of 310-380 nm of less than 6%. The lamination may further include a metal or metal oxide layer. The metal or metal oxide layer may be transparent.

Additional advantages of this invention will become readily apparent to those skilled in this art from the following detailed description, wherein preferred embodiments of this invention are shown and described. As will be realized, this invention is capable of other and different embodiments, and its details are capable of modifications in various obvious respects, all without departing from this invention. Accordingly, the drawings and description are to be regarded as illustrative in nature and not as restrictive.

### DETAILED DESCRIPTION OF THE INVENTION

Described are biaxially oriented films including a bio-based polyester which is derived from non-petroleum-sourced monomers. Also described are multi-layer biaxially oriented polyester films and laminates of same, which are made from at least one bio-based polyester building block, such as bio-based ethylene glycol or bio-based terephthalic acid. One example of such a film-forming polyester is polyethylene terephthalate (abbreviated as “PET”) homopolymer or copolymer with one or both of its major monomer building blocks, terephthalic acid or ethylene glycol, derived from biological sources. These films and laminates are particularly suited for use as window films. Such films exhibit excellent clarity and light stability, substantially equivalent to their petroleum-based counterparts, while being derived wholly or partly from non-petroleum sources.

In one embodiment, the biaxially oriented polyester film is comprised of at least 1 pMC, 19 pMC, 21.5 pMC, 53 pMC or 105.3 pMC, containing bio-based polyester of about at least 29%, at least 32% and preferably, 100% biomass content. The film is comprised of at least a single layer B as a base or core layer. The content or percentage of the film of bio-based origin is determined by comparing the amount of radiocarbon (¹⁴C isotope) to a modern reference sample. Radiocarbon (also known as “carbon 14”, “C-14”, or “¹⁴C”) is a weakly radioactive, naturally occurring element in all living organisms. ¹⁴C is taken up continuously by the organism (plant or animal) over its lifetime; when the organism dies (or is harvested such as sugar cane or corn or other crops), this ¹⁴C uptake ceases. Thus, contemporary biomass—or materials and articles made from such biomass—has a significant amount of radiocarbon, typically about 100% radiocarbon. In comparison, fossil fuels such as coal and petroleum oil have typically about 0% radiocarbon. This is because fossil fuels and petroleum were formed hundreds of millions of years in the past from buried plants and algae to form coal and petroleum deposits. The algae and plants from that time period ceased uptake of ¹⁴C and—as ¹⁴C has a half-life of about 5730 years, over those 300 million years or so since the original algae and plants died and turned into fossil fuels—the ¹⁴C isotope in them decayed to the point where such fossil fuels essentially contain zero radiocarbon. By comparing the amount of ¹⁴C in a bio-based polyester film to a “modern reference standard,” this ratio can be representative of a percent biomass content of the film with the units “pMC” (percent modern carbon).

The “modern reference standard” used in radiocarbon dating is a NIST (National Institute of Standards and Technology) standard with a known radiocarbon content equivalent to about the year 1950 AD. The year 1950 was chosen since it was the year that calibration curves for radiocarbon dating were established and also was a useful marker year prior to large-scale thermo-nuclear weapons testing which altered the global ratio of ¹⁴C to ¹²C. This standard represents 100 pMC. Present day (post-1950 AD) articles made from contemporary biomass sources typically show pMC greater than 100 due to the increase of ¹⁴C due to nuclear weapons testing (also known as “bomb carbon”). At the time of this writing, contemporary biomass-sourced articles have about 105.3 pMC. Thus, bio-based polyesters, e.g. polyethylene terephthalate using exclusively as diol component ethylene glycol recently derived from sugar cane or corn starches (which were subsequently fermented to ethanol or methanol and converted to ethylene, and then to ethylene oxide and ethylene glycol) and also using exclusively as diacid component terephthalic acid derived from biomass, would show a pMC of about 105.3. Fossil fuel/petroleum-based articles or polyesters would have a pMC of about 0. Thus, conventionally, it has been useful and convenient to assign a value of “100% biomass content” to articles that exhibit about or near 105.3 pMC and “0% biomass content” to articles that exhibit about or near 0 pMC. In this way, one can calculate and assign a percent biomass content to articles that comprise both bio-based carbon and fossil fuel-based carbon. For example, a polyethylene terephthalate film made from a bio-based ethylene glycol source and a conventional (petroleum-based) terephthalic acid would have 20 wt % bio-sourced carbon atoms (since in the PET repeat unit there are 2 carbon atoms coming from ethylene glycol and 8 carbon atoms coming from terephthalic acid) and would exhibit a pMC of about 21.1. This would equate to about “30% biomass content” for said film (Reference material from Beta Analytic Inc. website www.beta1abservices.com “Explanation of Results—Biobased Analysis using ASTM D6866”).

In some embodiments, the bio-based film layer B is a crystalline polyethylene terephthalate and can be uniaxially or biaxially oriented. These resins have intrinsic viscosities between 0.60 and 0.85 dl/g, a melting point of about 255-260° C., a heat of fusion of about 30-46 J/g, and a density of about 1.4. The pMC value of these crystalline polyesters is preferably at least about 21.5, and more preferably about 107.5. The bio-based resin layer B is typically 2 μm to 350 μm in thickness after biaxial orientation, preferably between 3 μm and 50 μm, and more preferably between 12 μm and 23 μm in thickness.

The layer can further include other additives. Additional preferred additives in the layer may include antiblock and slip additives. These are typically solid particles dispersed within the layer effectively to produce a low coefficient of friction on the exposed surface of the layer. This low coefficient of friction helps the film to move smoothly through the film formation, stretching and wind-up operations. Without such antiblocking and slip additives, the outer surfaces would be more tacky and would more likely cause the film being fabricated to stick to itself and to processing equipment causing excessive production waste and low productivity.

Examples of antiblock and slip additives that may be used for polyester film applications include amorphous silica particles with mean particle size diameters in the range of 0.050-0.1 μm at concentrations of 0.1-0.4 mass-percent, calcium carbonate particles with a medium particle size of 0.3-1.2 μm at concentrations of 0.03-0.2 mass-percent. Precipitated alumina particles of sub-micron sizes may be used with an average particle size, for example, of 0.1 μm and a mass-percent of 0.1-0.4. Additional examples include inorganic particles, aluminum oxide, magnesium oxide, and titanium oxide, such complex oxides as kaolin, talc, and montmorillonite, such carbonates as calcium carbonate, and barium carbonate, such sulfates as calcium sulfate, and barium sulfate, such titanates as barium titanate, and potassium titanate, and such phosphates as tribasic calcium phosphate, dibasic calcium phosphate, and monobasic calcium phosphate. Two or more of these may be used together to achieve a specific objective. As examples of organic particles, vinyl materials as polystyrene, crosslinked polystyrene, crosslinked styrene-acrylic polymers, crosslinked acrylic polymers, crosslinked styrene-methacrylic polymers, and crosslinked methacrylic polymers, as well as such other materials as benzoguanamine formaldehyde, silicone, and polytetrafluoroethylene may be used or contemplated.

The polyester resin layer preferably includes 50 to 100 ppm of a conductive metal compound, preferably manganese (Mg) and/or magnesium (Mn). The conductive metal compound can be added during the polymerization process as a catalyst or additive, or during the extrusion process in a masterbatch form to secure enough conductivity for electric pinning in the film-making process. Less than 50 ppm of the metal compound may cause pinning issues, more than 100 ppm of the metal compound may degrade the hydrolysis and transparency performance.

Examples of manganese compounds that may be used include manganese chloride, manganese bromide, manganese nitrate, manganese carbonate, manganese acetylacetonate, manganese acetate tetrahydrate, and manganese acetate dihydrate. Examples of magnesium compounds that may be used include magnesium chlorides and carboxylates. Magnesium acetate is a particularly preferred compound.

Additional additives, for example, phosphorous (P) can be used to suppress coloring (yellowness) of the polyester and can be added in an amount of between 30 to 100 ppm. Less than 30 ppm may not sufficiently reduce undesirable coloring of the film, but more than 100 ppm may make the film hazier.

The phosphorus-based compound is preferably a phosphoric acid-based compound, a phosphorous acid-based compound, a phosphonic acid-based compound, a phosphinic acid-based compound, a phosphine oxide-based compound, a phosphonous acid-based compound, a phosphinous acid-based compound, or a phosphine-based compound from the standpoint of thermal stability, suppression of debris, and improving hue. Phosphoric acid-based and phosphonic acid-based compounds are particularly preferable.

Other additives may include UV light absorbers. These additives may be used, for example, in window and solar film applications. UV light absorbers include, for example, benzoxazole, benzoxazinone, benzotriazole, and benzotriazine typos of UVA (UV absorbent) compounds. Particular examples for window films include 2,2′-(1,4-phenylene)bis([3,1]benzoxazin-4-one), commercially available from Cytec Industries under the tradename CYASORB UV-3638; 2,2′-methylene bis[6-(2H-benzotriazol-2-yl)-4-1,1,3,3-tetramethylbutyl)phenol], commercially available from BASF as TINUVIN 360; 2-(4,6-diphenyl-1,3,5-triazin-2-yl)-5-hexyloxyphenol commercially available from BASF under trade name TINUVIN 1577 ED; higher molecular weight triazines such as 2,4-bis-biphenyl-6-[2-hydroxy-4-(2-ethyl-hexyloxy)phenyl]-1,3,5-triazine. Such additives have varying performance depending not only on the percentage of total light transmittance in the UV (300-400 nm) range but also their long terms stability, allowing film customization to specific cost/performance point.

When a UVA preferentially absorbs the UV light, it forms intermediate molecular structures with higher energy. They reversibly return to their original form by dissipating the energy as harmless heat (IR) through the polymer matrix. Therefore, UVA can not only protect the plastic materials from degradation, but also prevent the harmful UV from reaching the items behind the plastics. Hence the value of UVA incorporated in window films is not only in terms of protecting the film itself against the harmful effects of sunlight but also preventing UV light from entering the building interior.

However, because UVAs obey Beer's law, which means the absorbance is proportional to the thickness and concentration, there will always be some UV light not absorbed that can then get into polymer matrix. This is especially true for the surface layer facing the light. Accordingly, one or more radical scavenging Hindered Amine Light Stabilizers (HALS) may be used together with one or more UVAs to protect the polymer materials. HALS works in a different way than UVA. When some UV light is not absorbed, free radicals that cause polymer degradation can be produced. HALS react with these free radicals and prevent further degradation by these radicals. The HALS used preferably meet all the preferred requirements for UVAs (high thermal stability, low volatility, low or no color and compatibility with the polymer). Additionally, they should not react with the polymer and the UVA.

The bio-based crystalline polyester resin can be polymerized by polycondensation between two or more building blocks with diacid and diester functionality, at least one of which is plant-sourced. One process or method to produce such plant-sourced monomer, namely ethylene glycol, is to ferment sugar cane or other plant sugars and starches and distill into ethanol (CH3-CH2-OH). Through a dehydration process using mineral acids, strong organic acids, suitable catalysts and combinations thereof, the ethanol can be converted to ethylene monomer (CH2=CH2), which in turn can be oxidized into ethylene oxide

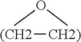

from which ethylene glycol (HO—CH2-CH2-OH) is derived by hydrolysis. One convenient low-cost source of sugar is the molasses generated as a by-product during the manufacture of sugar.

Diacids can also be derived from plant sources. For example there are several routes published for deriving terephthalic acid from biomass. Some of those routes are described in US Patent Application 2009/0246430 A1: one route involves extracting limonene from at least one bio-based material (for example citrus fruit peels), converting the limonene to at least one terpene, converting the terpene to p-cymene, and oxidizing the p-cymene to terephthalic acid:

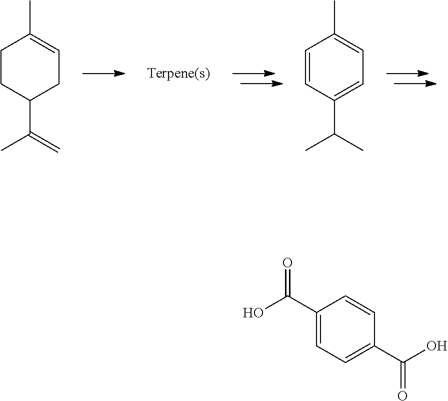

Another possible route to bio-terepththalic acid described in US Pat. Application 2009/0246430 A1 is through extraction of hydroxymethylfurfural from a bio-based material, such as corn syrup, sugars, or cellulose, converting hydroxymethylfurfural to a first intermediate, reacting the first intermediate with ethylene (which can also be derived from bio-sources such as described in paragraph 23) to form a second intermediate, treating the second intermediate with an acid in the presence of a catalyst to form hydroxymethyl benzaldehyde and oxidizing hydroxymethylbenzaldehyde to terephthalic acid.

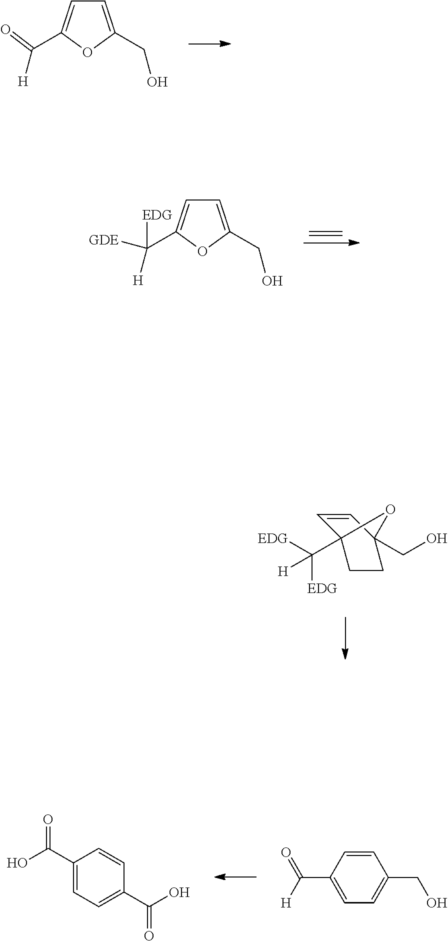

Another bio-derivative of plant-based hydroxymethylfurfural is 2,5-furandicarboxylic acid,

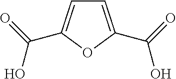 [SMILES: O=C(O)c1ccc(C(=O)O)o1]

(FDCA) derived by a catalytic oxidation.
FDCA can be used as the bio-diacid source for preparing polyester films. For example, condensation of FDCA with ethylene glycol provides polyethylene 2,5-furanedicarboxylate (PEF); preparation and physical properties of PEF are described by A. Gandini et al. (Journal of Polymer Science Part A: Polymer Chemistry Vol. 47, 295-298 (2009): its melting and crystallization behavior follow the same pattern as those of PET (i.e. a crystallization rate slow enough for its melt to be able to be quenched into the amorphous state but high enough to enable achieving high crystallinity by heating from amorphous or cooling from the melt; these attributes are essential for a drop-in adaptation in a PET-type biaxially oriented film manufacturing process), with a glass transition temperature (following quenching) at 75-80° C. and a melting temperature of 210° C. (45° C. lower than that of PET). A conference presentation by the Avantium Company (“Avantium's YXY: Green Materials and Fuels”, 2^{nd} Annual Bio-Based Chemicals Summit, Feb. 15, 2011) reports that PEF has been processed into bottles and film with superior gas and moisture barrier properties vs. PET; however the presentation makes no mention of multilayer or laminated films containing PEF. Also there is no mention of taking advantage of the lower melting temperature of PEF for the purpose of utilizing it in the heat-sealable layer of a coextruded film. Furthermore such a PEF film might exhibit, in view of its lower melting point, higher thermal shrinkage versus PET at the same temperature and, thus it may find application as a shrinkable label for a PET bottle. Today different polymeric materials are used as shrinkable labels, e.g. amorphous materials such as polystyrene, PVC, or PETG. The use of such materials make the empty bottles difficult to recycle without removing the label first. However, a PEF label will not need to be removed prior to recycle, since the material can be crystallized and reprocessed similar to PET and—at the levels present (as label weight versus bottle weight)—will be compatible with PET and not expected to significantly affect the physical properties of the article derived from recycling and reprocessing. A bio-based PEF film material can have pMC ranging between about 80.6 and 107.5 depending on whether only the FDCA component or both the FDCA and EG are bio-sourced.

Another route towards bio-based terephthalic acid is through the intermediate preparation of trans, trans muconic acid

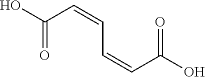

from biomass. A preparation method for cis, cis and cis, trans muconic acid from biomass (such as starches, sugars, plant material, etc.) through the biocatalytic conversion of glucose and others sugars contained therein, is described in U.S. Pat. No. 5,616,496. A subsequent isomerization of the above isomer mix into trans, trans muconic acid, necessary for conversion into terephthalic acid by reacting with dienophiles is described in US patent application 20100314243.

Yet another route towards bio-based terephthalic acid is converting carbohydrates derived from corn or sugarcane and potentially from lignocellulosic biomass into bio-isobutanol via fermentation by employing appropriate yeasts. Such processes are described for example in US Patent Applications 20090226991 and 20110076733. The biologically-sourced isobutanol in turn is converted to para-xylene through a series of intermediate steps, according to procedures such as those described in US patent application 20110087000. The bio-sourced para-xylene in turn is oxidized to bio-terephthalic acid through commercially known oxidation/purification processes.

Other embodiments can comprise multi-layer films in which each respective layer is comprised of a bio-based polyester of at least about 19 pMC or at least about 21.5 pMC. For example, the layer B comprising a bio-based PET can have a contiguous skin layer A coextruded upon one side of layer B. If desired, a second skin layer C can be coextruded upon the side of layer B opposite the side in contact with layer A. It can be contemplated to interpose additional intermediate layers between the layers A and B and between B and C, in either symmetric or asymmetric structures. Preferably, all these additional layers—A, C, and intermediate layers—are comprised of bio-based polyester of at least about 19 pMC or at least 21.5 pMC.

These skin layers A and C can be coextruded on the respective sides of the core layer B, each skin layer having a thickness after biaxial orientation between 0.1 and 10 μm, preferably between 0.2 and 5 μm, and more preferably between 0.5 and 2.0 μm. In a further embodiment in which the layer A's outer surface is used for receiving a vapor-deposited metal (and/or metal oxides or silicone oxides) or for receiving printing inks or coatings (for adhesives, gas barrier materials, solvent or aqueous) it is also contemplated to add an antiblock to aid in film handling. The bio-based layer A can be optionally surface-treated with either a corona-discharge method, flame treatment, atmospheric plasma, or corona discharge in a controlled atmosphere of nitrogen, carbon dioxide, or a mixture thereof, or to use chemical treatments such as isophthalic acid-based polyester or polyester dispersion coatings, to improve wetting tension further for the improved receptivity of said vapor-deposited metal, inks, adhesives, or coatings. The treatment method using corona discharge in a controlled atmosphere mixture of CO₂ and N₂ (to the exclusion of O₂) is particularly preferred. This method of discharge treatment results in a treated surface that comprises nitrogen-bearing functional groups, preferably 0.3% or more nitrogen in atomic %, and more preferably 0.5% or more nitrogen in atomic %. A wetting tension of at least 36 dyne-cm/cm² is preferred, and more preferably, a wetting tension of 39-48 dyne-cm/cm². This treated layer can then be metalized, printed, coated, or extrusion or adhesive laminated.

Additionally, in the embodiment of only a single bio-based polyester layer B, one or both surfaces of layer B may be discharge-treated for similar purposes as described above.

The bio-based layer C can be a heat-sealable layer or non-heat sealable layer contiguously coextruded with the core layer B opposite the layer A. As a heat-sealable layer, layer A may contain an anti-blocking agent and/or slip additives for good machinability and a low coefficient of friction. The heat-sealable layer will be preferably a bio-based PET copolymer or a bio-based PEF homopolymer, comprising at least about 19 pMC or at least about 21.5 pMC, and preferably at least about 80.5 pMC. A bio-based PET copolymer will preferably comprise a terephthalate-co-isophthalate copolymer with ethylene glycol, and further preferably, comprising of at least 16 pMC or at least about 21.5 pMC. In the embodiment in which layer C comprises a non-heat sealable, winding layer, this layer will comprise a crystalline PET with anti-blocking and/or slip additives. Preferably, said winding layer is comprised of at least about 19 pMC or at least about 21.5 pMC bio-based polyesters.

As mentioned previously, the outer layers A and C can include antiblock and slip additives for controlling COF and web handling. These are typically solid particles dispersed within the outer layer to produce a low coefficient of friction on the exposed surface of the outer layer(s). This low coefficient of friction helps the film to move smoothly through the film formation, stretching and wind-up operations. Without such antiblocking and slip additives, the outer surfaces would be more tacky and would more likely cause the film being fabricated to stick to itself and to processing equipment causing excessive production waste and low productivity.

Examples of antiblock and slip additives that may be used for polyester film applications include amorphous silica particles with mean particle size diameters in the range of 0.050-0.1 μm at concentrations of 0.1-0.4 mass-percent, calcium carbonate particles with a medium particle size of 0.3-1.2 μm at concentrations of 0.03-0.2 mass-percent. Precipitated alumina particles of sub-micron sizes may be used with an average particle size, for example, of 0.1 μm and a mass-percent of 0.1-0.4. Additional examples include inorganic particles, aluminum oxide, magnesium oxide, and titanium oxide, such complex oxides as kaolin, talc, and montmorillonite, such carbonates as calcium carbonate, and barium carbonate, such sulfates as calcium sulfate, and barium sulfate, such titanates as barium titanate, and potassium titanate, and such phosphates as tribasic calcium phosphate, dibasic calcium phosphate, and monobasic calcium phosphate. Two or more of these may be used together to achieve a specific objective. As examples of organic particles, vinyl materials as polystyrene, crosslinked polystyrene, crosslinked styrene-acrylic polymers, crosslinked acrylic polymers, crosslinked styrene-methacrylic polymers, and crosslinked methacrylic polymers, as well as such other materials as benzoguanamine formaldehyde, silicone, and polytetrafluoroethylene.

As mentioned previously in describing layer B, layers A and C may also include UV protective additives such as UV light absorbers, especially in applications related to window and solar film applications. These include for example benzoxazole, benzoxazinone, benzotriazole, and benzotriazine typos of UVA (UV absorbent) compounds. Additionally they may contain free radical scavengers, such as hindered amine light scavengers, as described previously.

For the embodiments in which the biaxially oriented multilayer bio-based polyester is PET-based, the coextrusion process includes a two- or three-layered compositing die. In the case where a three-layer die is employed, the bio-based polyester core layer B is sandwiched between the skin layer A and the heat sealable layer C. In general, a preferred extrusion process for producing the polyester film, masterbatch and crystallizable polyester feed particles are dried (to preferably less than 100 ppm moisture content) fed to a melt processor, such as a mixing extruder. The molten material, including the additives, is extruded through a slot die at about 285° C. and quenched and electrostatically-pinned on a chill roll, whose temperature is about 20° C., in the form of a substantively amorphous prefilm. The film may then be reheated and stretched longitudinally and transversely; or transversely and longitudinally; or longitudinally, transversely, and again longitudinally and/or transversely. The preferred is sequential orientation of first longitudinally, then transversely. The stretching temperatures are generally above the Tg of the film polymer by about 10 to 60° C.; typical machine direction processing temperature is about 95° C. Preferably, the longitudinal stretching ratio is from 2 to 6, more preferably from 3 to 4.5, with typical transverse direction processing temperature about 110° C. Preferably, the transverse stretching ratio is from 2 to 5, more preferably from 3 to 4.5. Preferably, any second longitudinal or transverse stretching is carried out at a ratio of from 1.1 to 5. The first longitudinal stretching may also be carried out at the same time as the transverse stretching (simultaneous stretching). Heat setting of the film may follow at an oven temperature of about 180 to 260° C., preferably about 220 to 250° C., typically at 230° C., with a 5% relaxation to produce a thermally dimensionally stable film with minimal shrinkage. The film may then be cooled and wound up into roll form.

As described previously, one or both sides of the film can be coated or treated for adhesion promotion, surface conductivity, higher wetting tension etc. Preferred treatments include known methods such as corona treatment, plasma treatment, flame treatment, corona treatment in a controlled atmosphere of gases, and in-line coating methods.

A preferred embodiment is to metalize the discharge-treated surface of the bio-based laminate film to improve gas barrier properties such as oxygen and moisture vapor. The unmetalized laminate sheet is first wound in a roll. The roll is placed in a metalizing vacuum chamber and the metal vapor-deposited on the discharge-treated bio-based polymer resin layer surface by high speed vapor deposition metalizing processes well known in the art. The metal film may include titanium, vanadium, chromium, manganese, iron, cobalt, nickel, copper, zinc, aluminum, gold, or palladium, the preferred being aluminum. Metal oxides can also be contemplated, the preferred being aluminum oxide. The metal layer shall have a thickness between 5 and 100 nm, preferably between 20 and 80 nm, more preferably between 30 and 60 nm; and an optical density between 1.5 and 5.0, preferably between 2.0 and 4.0, more preferably between 2.3 and 3.2. The metalized film is then tested for oxygen and moisture permeability, optical density, and metal adhesion. Preferred gas barrier values are in the range of 5-50 cc/m²/day oxygen transmission rate at 23° C. and 0% RH, and more preferably less than 31 cc/m²/day or less. Preferred moisture barrier values are in the range of 0.03-0.70 g/m²/day water vapor transmission rate at 38° C. and 90% RH, and more preferably less than 0.31 g/m²/day.

Thus, basic bio-based polyester film designs can be envisioned for different purposes such as metalizing, printing, coating etc. and these various films may also be combined together in laminations to provide suitable packaging films.

In a further set of embodiments, it is contemplated that a bio-based BOPET film designed as a transparent print film for receiving printing inks as described above may be laminated to a metalized bio-based BOPET film designed as a heat sealable metalizing basefilm as described above. The laminating adhesive may be solvent-borne, aqueous-borne, solventless, or extrusion types. If extrusion, a particularly preferred extrudate would be a bio-based low density polyethylene of at least 53 pMC and preferably about or near 105.3 pMC so as to maximize overall biomass content of the lamination structure. The preferred configuration for such a laminate would be: 1) a bio-based print OPET film reverse-printed with ink; 2) an aluminum metalized bio-based heat sealable OPET with the aluminum metal deposited upon the side of the film opposite the heat sealable layer; 3) the two bio-based OPET films are then adhered to each other using molten bio-based low density polyethylene with the reverse-printed side of the bio-based print OET film adhered to the aluminum metalized side of the bio-based metalized OPP film. Other bio-based OPET film designs can be contemplated and lamination structures envisioned. Such bio-based laminations may comprise more than 2 films laminated together; also contemplated is a mono-layer or single bio-based OPET film used for various purposes. A preferred purpose for such contemplated laminations is for flexible packaging, in particular for snack food packaging.

Similar to the above-described method to produce bio-based BOPET films and laminates, similar films can be produced using bio-based polypropylene or bio-based polyetheylene films to produce laminates or combinations of bio-based biaxially oriented polyolefin films and bio-based BOPET in laminate structures. Frequently a metalized BOPP serves as the metalized layer and clear printable BOPET serves as the non-metalized layer. A bio-based BOPP film can be made by sequential or simultaneous orientation processes well-known in the art using a core layer (B) of substantially bio-based polypropylene.

The films and laminates can be used as a PET window film. For example, U.S. Pat. No. 6,416,872, the disclosure or which is hereby incorporated by reference in its entirety shows a typical construction of a glazing involving two PET window films, one as carrier of UV blocker and the other as substrate for heat reflecting interference layers and a infrared reflecting metal layer. As described in this patent, a composite can be formed as follows: 4 millimeter thick glass (exterior side), 0.01 millimeter thick first PET film layer impregnated with UV blocking dye/absorber, a 0.001 mm thick laminating adhesive layer (index 1.50), a first heat reflecting interference layer, for example a 55 nm tin oxide layer, an infrared reflecting metal layer, for example a 12 nm silver layer, a second heat reflecting interference layer, for example a 45 nm tin oxide layer, a second PET film layer (substrate for thin film metal and metal oxide layers), and a 0.001 mm acrylate scratch resistant layer.

Additional descriptions of window assemblies involving PET window films are provided in U.S. Pat. Nos. 7,238,401, 7,919,158, 6,455,141; 6,455,141; 6,188,512; and 6,034,813. The descriptions of these patents are hereby incorporated by reference in their entirety.

### Testing Methods and Film Characteristics

Oxygen transmission rate of the film was measured by using a Mocon Oxtran 2/20 unit substantially in accordance with ASTM D3985. In general, the preferred value was an average value equal to or less than 1.5 cc.mm/m²/day at 73° F. (23° F.).

Moisture transmission rate of the film was measured by using a Mocon Permatran 3/31 unit measured substantially in accordance with ASTM F1249. In general, the preferred value was an average value equal to or less than 0.54 g.mm/m²/day at 100° F. (38° C.) and 90% relative humidity.

Optical density was measured using a Tobias Associates model TBX transmission densitometer. Optical density is defined as the amount of light reflected from the test specimen under specific conditions. Optical density is reported in terms of a logarithmic conversion. For example, a density of 0.00 indicates that 100% of the light falling on the sample is being reflected. A density of 1.00 indicates that 10% of the light is being reflected; 2.00 is equivalent to 1%, etc.

Wetting tension of the surfaces of interest was measured substantially in accordance with ASTM D2578-67. In general, the preferred value was an average value equal to or more than 40 dyne/cm with a minimum of 36 dyne/cm.

Radiocarbon/biomass content pMC was measured substantially in accordance with ASTM D6866-10 “Renewable Carbon Testing” procedure. Analytical methods used to measure ¹⁴C content of respective bio-based and petroleum-based polyolefin materials and articles made include Liquid Scintillation Counting (LSC), Accelerator Mass Spectrometry (AMS), and Isotope Ratio Mass Spectroscopy (IRMS) techniques. Bio-based content is calculated by deriving a ratio of the amount of radiocarbon in the article of interest to that of the modern reference standard. This ratio is reported as a percentage of contemporary radiocarbon (pMC or percent modern carbon) and correlates directly to the amount of biomass material present in the article.

Heat seal strength is measured by using a Sentinel sealer model 12 ASL at 30 psi (206.8 Pa), 0.5 second dwell time, with heated flat upper seal jaw Teflon coated, and unheated lower seal jaw, rubber with glass cloth-covered. The film is heat-sealed sealant-side to sealant-side at the desired seal temperature range and increments in the Sentinel sealer (e.g. 250-400° F. at 10° F. (121.1° C.-204.4° C. at 5.56° C.) increments) and then the respective seal strengths are measured using an Instron model 4201 tensile tester. The heat-sealed samples are cut into 1-inch (25 mm) wide strips, the two unsealed tails are placed in the upper and lower Instron clamps and the sealed tail supported at a 90° angle to the two unsealed tails for a 90° T-peel test. The peak and average seal strength is recorded. The preferred values for acceptable heat seal strength is 400 g/25 mm or greater at 300° F. (149° C.) seal temperature.

Hot tack strength is measured by using a Lako Tool hot tack/sealer model SL10 at 30 psi (206.8 Pa), 0.5 second dwell time, with heated flat lower seal jaw Teflon coated, and unheated upper seal jaw and with delay set to 0 seconds. The film sample is cut into a strip 13 inches (330 mm) long by 1 inch (25 mm) wide and fitted into the Lako SL10 film holder. The film is then heat-sealed sealant-side to sealant-side at the desired seal temperature range and increments in the Lako sealer (e.g. 180-290° F. at 10° F. (82.2° C. at 5.56° C.) increments) and then the respective hot tack strengths are measured by the Lako SL10 sealer automatically. The peak hot tack strength is recorded. The preferred values for acceptable hot tack is 150 g/25 mm or greater at 300° F. (149° C.) seal temperature.

Heat seal and hot tack seal initiation temperature (SIT) is measured by using the above methods (A) and (B) using the Sentinel 12 ASL or Lako Tool SL10 hot tack sealer. Heat seal initiation temperature is the lowest temperature at which minimum 200 g/25 mm seal strength is achieved. Hot tack initiation temperature is the lowest temperature at which minimum 150 g/25 mm hot tack is achieved. Initiation temperatures of 265° F. (129.4° C.) or less are preferred.

Transparency of the film was measured by measuring haze of a single sheet of film substantially in accordance with ASTM D1003.

COOH content of the film and resin were tested according to ASTM D 7409-07. The procedure involves the titration of the carboxyl end groups with potassium hydroxide in an o-cresol/chloroform medium to a bromophenol blue endpoint. A known weight of PET sample is dissolved in o-cresol then chloroform and bromophenol blue are added to the solution. The solution is then titrated with potassium hydroxide until the color changes to blue as a result of the end group reaction. Based on the amount of KOH required for the titration, the quantity of carboxyl end groups is calculated. A COOH content of the film 5-20 eq/ton is considered good.

Intrinsic viscosity (IV) of the film and resin were tested according to ASTM D 460. This test method is for the determination of the inherent viscosity of poly(ethylene terephthalate) (PET) soluble at 0.50% concentration in a 60/40 phenol/1,1,2,2-tetrachloroethane solution by means of a glass capillary viscometer. An IV of 0.65 to 0.75 is considered good for film.

Tensile strength and elongation percent at break of the film were determined according to ASTM D882 using a Tensilon tester. The average number of machine direction and transverse direction is used.

The Mn, Mg, and P content of the films were measured using a RIGAKU RIX 1000 X-Ray Fluorescent Spectrophotometer (FLX). This non-destructive method consists of irradiating a solid sample with an intense X-ray beam. The sample thus excited absorbs some of the energy and in turn emits X-rays along a spectrum of wavelengths characteristic of the types of atoms present in the sample; and the intensity of these emitted X-rays is proportional to the abundance of the elements in the sample. The desirable range is 50-100 ppm of Mn and/or Mg, and 30-100 ppm of P.

The melt volume resistivity of the films were measured by placing 14 grs of the material in a test tube, and then placing the tube in a block heater until the material completely melted (typically in 2-3 minutes). Next, parallel thin metal probes connected to a resistomer were dipped into the melt and the resistance was measured.

Metal adhesion was measured by heat sealing on a SENTINAL Sealer model 12 ASL at 220° F. (104.4° C.) seal temperature, 15 second dwell, and 15 psi (103.42 kPa) seal jaw pressure, a piece of 1-mil (25 μm) thick Ethylene Acrylic Acid polymer film (EAA) to the metalized surface of a single sheet of metalized film and measuring the 180° peel strength of the metal from the substrate substantially in accordance with AIMCAL (Association of Industrial Metalizes, Coaters, and Laminators) test procedure TP-105-92. The test procedure and a kit of materials can be obtained from AIMCAL's website www.aimcal.com. The Metal Adhesion Test Kit is designed to permit testing using TP-105-92. The test kit contains 2 rolls of 3M™ tape #610, 2 rolls of EAA film and an AIMCAL Metalizing Technical Reference Manual. The test kit contains enough material to do at least 100 tests as described in the Technical Reference Manual, (TP-105-92). The test procedure used in testing the samples used in the examples of this application is described in AIMCAL Metalizing Technical Reference (Third Edition, © 2001). In general, preferred values of metal adhesion ranged from about 50 g/in (50 g/25 mm) minimum or higher.

Metal appearance was rated qualitatively using a ranking system of 1-4, with 1 equating to a very matte or high density of defects (e.g. die lines, gels, etc) metalized film appearance and 4 equating to a very shiny, glossy, reflective, defect-free metalized film appearance. 8½″×11″ cut sheet samples of the metalized films were observed on a white background under office fluorescent lighting, and ranked in order of metal shininess. The preferred rating is a “4” and with “2” as minimum acceptability.

Specific UV absorbent materials, UVAs, were admixed into PET chip having an intrinsic viscosity (IV) of 0.65. The resultant blend was extruded onto a casting drum to produce a PET sheet of about 1.0 mil thickness. The UVA properties of the polyester films were measured via the use of a Hitachi U-3900H UV/VIS spectrophotometer. UV transmission spectra were taken and the percentage of total transmittance was calculated from 300 nm to 400 nm. The films has an average UV transmission in the range of 300-400 nm of less than 18%, and has an average UV light transmission in the range of 310-380 nm of less than 6%.

Friction was measured with the use of a Testing Machine, Inc. slip tester (TMI-Model #32-06) using ASTM D1894-95. Polyester film samples were cut to specified sizes. One sheet of polyester was clamped, “A” surface up, onto a 18″ MD (machine direction)×6″ TD (transverse direction) glass plate. Another piece of polyester film was mounted using double-sided tape to a 2.5″×2.5″200 g sled, with the “B” surface down. The sled was placed on top of the glass plate and attached to the load sensing device. The sled was then dragged over the film on the glass plate at 6 in/min. The only contact during the testing was polyester film surface “A” rubbing against polyester film surface “B”. The measuring distance used to calculate the value of μₛ is was 1″ and 4″ for μ_{d}.

Film handling properties are directly related to the friction properties of the film. A high coefficient of friction tends to lead to difficult converting of the film due to difficulties in unwinding the film and in subsequent re-winding of the film due to the possibility of increased static and the requirements for higher load tensions to pull the film through the typical roller train used in converting processes. High coefficients of friction can also lead to end user roll formation issues such as pimples and high edges. For easy converting of the film the film is preferably created to have a static coefficient of friction (μₛ) of less than or equal to about 0.55 together with a dynamic coefficient of friction (μ_{d}) of less than or equal to about 0.45.

Average surface roughness (Ra) was measured using Kosaka Laboratory Limited Model #SE-30AK and #Ay-31. The average value of the data of 10 times measurements was taken as the surface roughness of the film according to the present invention. All measurements were run at 50,000× magnification and in the transverse direction of the film. The length of the measurement was 4 mm and the cut-off value was 0.08 mm. Preferably, the film has a surface roughness of less than or equal to 15 nm, preferably less than or equal to 10 nm, more preferably less than or equal to 7 nm.

This application discloses several numerical ranges in the text and figures. The numerical ranges disclosed inherently support any range or value within the disclosed numerical ranges even though a precise range limitation is not stated verbatim in the specification because this invention can be practiced throughout the disclosed numerical ranges.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein. Finally, the entire disclosure of the patents and publications referred in this application are hereby incorporated herein by reference.

We claim:

1. A bio-based polyester window film comprising a bio-based polyester, wherein the bio-based polyester window film has a radiocarbon content of at least 19 pMC.

2. The bio-based polyester window film of claim 1, further comprising a UV light absorber.

3. The bio-based polyester window film of claim 1, further comprising a Hindered Amine Light Stabilizer (HALS).

4. The bio-based polyester window film of claim 2, wherein the UV light absorber comprises 2,2′-(1,4-phenylene)bis([3,1]benzoxazin-4-one), 2,2′-methylene bis[6-(2H-benzotriazol-2-yl)-4-1,1,3,3-tetramethylbutyl)phenol], 2-(4,6-diphenyl-1,3,5-triazin-2-yl)-5-hexyloxyphenol, or 2,4-bis-biphenyl-6-[2-hydroxy-4-(2-ethyl-hexyloxy)phenyl]-1,3,5-triazine.

5. The bio-based polyester window film of claim 2, wherein the UV light absorber comprises a triazine.

6. The bio-based polyester window film of claim 2, wherein the film has an average UV light transmission in the range of 300-400 nm of less than 18%.

7. The bio-based polyester window film of claim 2, wherein the film has an average UV light transmission in the range of 310-380 nm of less than 6%.

8. The bio-based polyester window film of claim 1, wherein the film is biaxially oriented.

9. The bio-based polyester window film of claim 1, wherein the bio-based polyester comprises crystalline polyethylene terephthalate.

10. The bio-based polyester window film of claim 1, wherein the bio-based polyester's bio-based renewable source is derived from cane sugar, beet sugar, or corn sugar.

11. The bio-based polyester window film of claim 1, wherein one an outermost surface of the film is discharge-treated.

12. The bio-based polyester window film of claim 11, wherein the window film further comprises a metal or metal oxide layer.

13. The bio-based polyester window film of claim 12, wherein the metal or metal oxide layer is transparent.

14. The bio-based polyester window film of claim 1, further comprising an adhesive layer.

15. The bio-based polyester window film of claim 14, wherein the adhesive layer rejects UV radiation up to 380 nm.

16. A window structure comprising a window and the bio-based polyester window film of claim 1 on a surface of the window.

17. A lamination comprised of:
a first biaxially oriented bio-based polyester film comprising at least 19 pMC;
a second biaxially oriented bio-based polyester film comprising at least 19 pMC; and
an adhesive layer between the first biaxially oriented bio-based polyester film and the second biaxially oriented bio-based polyester film.

18. The lamination of claim 17, wherein the first or second bio-based biaxially oriented polyester film comprises a UV light absorber.

19. The lamination of claim 17, wherein the first or second bio-based biaxially oriented polyester film comprises a Hindered Amine Light Stabilizer (HALS).

20. The lamination of claim 18, wherein the UV light absorber comprises 2,2′-(1,4-phenylene)bis([3,1]benzoxazin-4-one), 2,2′-methylene bis[6-(2H-benzotriazol-2-yl)-4-1,1,3,3-tetramethylbutyl)phenol], 2-(4,6-diphenyl-1,3,5-triazin-2-yl)-5-hexyloxyphenol, or 2,4-bis-biphenyl-6-[2-hydroxy-4-(2-ethyl-hexyloxy)phenyl]-1,3,5-triazine.

21. The lamination of claim 18, wherein the UV light absorber comprises a triazine.

22. The lamination of claim 18, wherein the lamination has an average UV light transmission in the range of 300-400 nm of less than 18%.

23. The lamination of claim 18, wherein the lamination has an average UV light transmission in the range of 310-380 nm of less than 6%.

24. The lamination of claim 17, further comprising a metal or metal oxide layer.

25. The lamination of claim 21, wherein the metal or metal oxide layer is transparent.
